(19) United States
(12) Patent Application Publication
(10) Pub. No.: US 2022/0261026 A1
(43) Pub. Date: Aug. 18, 2022

(54) ISLANDING CONTROL USING MULTI-PORT METERS

(71) Applicant: Landis+Gyr Innovations, Inc., Alpharetta, GA (US)

(72) Inventors: Matt Karlgaard, Brainerd, MN (US); John Radgowski, Midlothian, VA (US); David Stenberg, West Lafayette, IN (US)

(21) Appl. No.: 17/670,382

(22) Filed: Feb. 11, 2022

Related U.S. Application Data
(60) Provisional application No. 63/148,910, filed on Feb. 12, 2021.

(51) Int. Cl. G05F 1/66; H02J 3/00; H02J 3/14; G05B 15/02; G06Q 50/06

(52) U.S. Cl. CPC G05F 1/66; H02J 3/004; G05B 2219/2639; G05B 15/02; G06Q 50/06; H02J 3/14

(57) ABSTRACT

A multi-port meter system supports islanding operations at a premises. A multi-port meter includes at least a load port, a grid port, an auxiliary port, and at least two switches, a grid switch and an auxiliary switch. The grid port connects the multi-port meter to the grid and the grid switch allows the multi-port meter to control the meter's connection to the grid. The auxiliary port connects the multi-port meter to an inverter, which is connected to a distributed energy resource device, and the auxiliary switch allows the multi-port meter to control the inverter's connection to the load associated with the premises and the grid. The transition to islanding mode may be based on determinations made at the meter, the inverter, a remote device, or by a user.

### RELATED APPLICATION

This application claims priority to U.S. Patent Application No. 63/148,910 filed Feb. 12, 2021, the entire contents of which is incorporated herein by reference.

### TECHNICAL FIELD

The present disclosure relates to control of a distributed energy resource device at a premises. The present disclosure relates in particular to the control of islanding operations using distributed energy resources and multi-port meters.

### BACKGROUND

In a resource distribution system, such as an electric grid that delivers electric power, a meter is used to measure and control consumption at a customer premises. The meter may include metrology components for measuring consumption and monitoring power characteristics and communications components for communicating with other devices on a network, as well as a central system, such as a head-end system. The meter may also include other modules and components.

When a distributed energy resource (DER) device, such as a solar panel array, wind turbine, water turbine, battery, an electric vehicle (EV) charger, EV, an energy storage device, or generator is located at a customer premises, the power generated or stored by the DER device may be metered by a multi-port meter and used at the premises or output to the electric grid. Additionally, the EV charger, EV, and energy storage device may also receive power from the electric grid for storage and use at a later time. In some systems, an inverter is coupled to the DER devices to convert DC power to AC grid power. A conventional inverter may be configured to operate in anti-islanding mode. In anti-islanding mode the inverter stops generation of power by the DER devices or stops outputting power when a grid power outage is detected at a premises. This may prevent voltage from being applied back to the grid from the DER devices during the power outage to protect workers working to restore grid power. Anti-islanding may prevent the premises from using DER power generated or stored at the premises during the outage. For example, even though a DER device may be capable of generating power usable at the premises, the inverter may not allow provision of the power to the premises when configured in an anti-islanding mode. Thus, there is a need for an improved system for controlling islanding operations of DER devices at a premises.

### SUMMARY

The present disclosure includes a multi-port meter that may be connected to an electric grid, one or more distributed energy resource (DER) devices, and at least one load. The electric grid may be connected to a grid port of the meter and the DER device may be connected to the meter through an inverter, which is connected to an auxiliary port of the meter. The meter includes a grid switch connected to the grid port and an auxiliary switch connected to the auxiliary port. It controls the states of the switches to support grid-tied operations or islanding operations.

In one aspect, the multi-port meter controls the switches based on its determination to transition between grid-tied mode and islanding mode. For example, the meter measures voltage characteristics of the electric grid, and when there is an outage on the electric grid, the multi-port meter may determine to transition to islanding mode. It opens the grid switch, disconnecting the multi-port meter from the electric grid and it closes the auxiliary switch or allows the auxiliary switch to remain closed so that the inverter may provide power the load. When the meter determines that power is restored on the grid, the meter may control the grid and auxiliary switches to initiate a transition back to grid-tied mode.

In other aspects of the invention the determination to transition between modes may be made by a system or device other than the meter. The decision may be made by the inverter and communicated to the meter or the decision may be made by a user and communicated to the meter. The decision also may be made by a remote system, such as a utility head-end system. The remote system may send commands to the meter or to the inverter instructing the device to transition between modes.

These examples are mentioned not to limit or define the limits of the present subject matter, but to provide an example to aid understanding thereof. Illustrative examples are discussed in the Detailed Description, and further description is provided there. Advantages offered by various examples may be further understood by examining this specification and/or by practicing one or more examples of the claimed subject matter.

### BRIEF DESCRIPTION OF THE FIGURES

These and other features, aspects, and advantages of the present disclosure are better understood when the following Detailed Description is read with reference to the accompanying drawings, where:

FIG. 1 is a block diagram illustrating an example of a multi-port meter and inverter system.

FIG. 2 is a block diagram illustrating an exemplary multi-port meter.

FIG. 3a is a block diagram of an exemplary multi-port meter configured to support grid-tied mode.

FIG. 3b is a block diagram of an exemplary multi-port meter configured to support islanding mode.

FIG. 3c is a block diagram of an exemplary multi-port meter configured in a first transitional state.

FIG. 3d is a block diagram of an exemplary multi-port meter configured in a second transitional state.

FIG. 4a is a state diagram illustrating exemplary states of the multi-port meter and the transitions between states.

FIG. 4b is a state diagram illustrating exemplary states of the multi-port meter and the transitions between states.

FIG. 5 is a flowchart illustrating an exemplary method of transitioning a multi-port meter and inverter system from islanding mode to grid-tied mode.

FIG. 6 is a flowchart illustrating an exemplary method of transitioning a multi-port meter and inverter system from grid-tied mode to islanding mode.

FIG. 7 is a block diagram of an exemplary multi-port meter and inverter system where the inverter monitors the grid.

FIG. 8 is a block diagram of an exemplary multi-port meter with an integrated inverter.

FIG. 9 is a block diagram of an exemplary multi-port meter and inverter system that includes an automatic transfer switch.

### DETAILED DESCRIPTION

Aspects of the present disclosure relate to a system for controlling islanding operations of distributed energy resource (DER) devices at a premises. Islanding refers to a DER device providing power to a premises when the premises is disconnected from the power grid or there is an outage on the power grid. In some implementations, the connections between the DER device, a multi-port meter, and the premises are referred to as a micro-grid. A micro-grid may operate without receiving power from the power grid.

DER devices may be commonly operably connected to an inverter, so that the inverter can regulate the power generated by the DER device so that the phase, amplitude, and frequency of the power generated complies with the required electrical ratings of devices within the micro-grid or the power grid. A DER device includes, but is not limited to, a solar panel array, wind turbine, water turbine, battery, an electric vehicle (EV) charger, EV, an energy storage device, or generator.

Some inverters may be configured to support islanding by providing a synchronous output and an isochronous output. When the inverter provides a synchronous output, its output voltage amplitude, frequency, and phase track the voltage amplitude, frequency, and phase of the grid. When the inverter provides an isochronous output, it determines its output voltage amplitude, frequency, and phase without tracking the grid. Many existing inverters are configured to only provide a synchronous output and operate in anti-islanding mode. In anti-islanding mode, the inverter stops providing power, typically by shutting down, when there is a power outage on the grid. Some inverters may be configurable so that they support both islanding mode and anti-islanding mode. For example, a parameter or a configuration bit in an inverter may be set upon manufacture or installation to a value that supports islanding mode or to a different value that supports anti-islanding mode. These types of inverters are generally connected to a switch that is separate from the meter so controlling the inverters is generally complex and expensive. One benefit of the present system is the integration of the auxiliary switch in the multi-port meter so that the output of the inverter can be controlled to support both grid-tied mode and islanding mode.

In the present solution, a determination to transition to islanding mode may now be made at the meter. Other examples of the present solution allow for the determination to enter islanding mode to be made at a remote system, such as at the utility head-end system, or at the inverter. The determination to transition to islanding mode by controlling the switches at the meter has the benefit of allowing islanding in response to or anticipation of a variety of conditions, including a change in the grid, a planned change in the grid, or other conditions that affect the availability of power.

A utility head-end system, or other remote system, may determine that scheduled maintenance requires that the inverter should be disconnected from the grid. By allowing control of islanding by the utility company through the meter, the utility may protect workers maintaining the grid from power being introduced into the grid by distributed energy resource devices. The control of the determination to island at the utility head-end system also allows the utility head-end system to transition a multi-port meter and inverter system to islanding mode during peak hours of distributed energy resource device power generation, such as a particular time of day for solar panels or on windy days for wind turbines.

Alternatively, the multi-port meter could receive information from a utility head-end system, and determine to transition to or from islanding mode based on information communicated from the utility head-end system. For example, prior to beginning scheduled grid maintenance, the utility head-end system may send a command to the multi-port meter to enter islanding mode. When the multi-port meter receives the information, the multi-port meter may determine that the system should transition to islanding mode, so that the user does not lose power at the premises during grid maintenance.

The remote system and multi-port meter are not limited to just the aforementioned examples for determining to transition the multi-port meter and inverter system to islanding mode. The remote system and multi-port meter may determine to transition the system to islanding mode for other reasons as well.

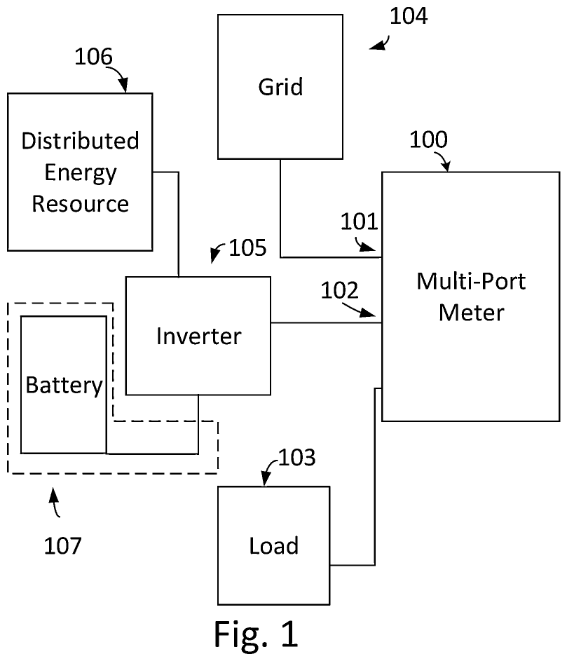

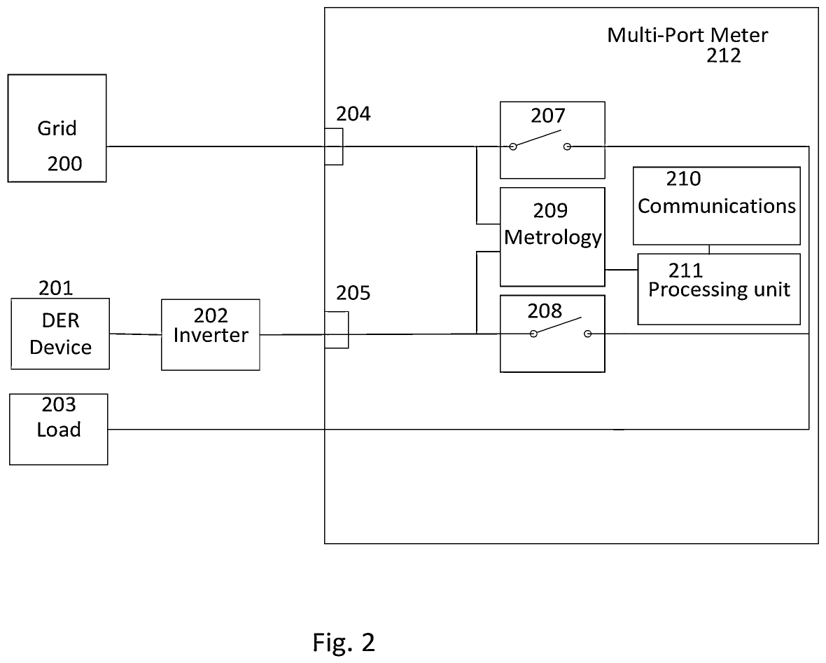

FIG. 1 illustrates an exemplary multi-port meter and inverter system. FIG. 1 depicts a multi-port meter 100 connected to an electric power grid 104 through a grid port 101 also called a grid connection, connected to an inverter 105 through an auxiliary port 102, also called a DER port, and connected to a premises load 103 through a load port. The inverter 105 is connected to one or more DER devices. In the figure, a DER device 106 and an optional battery 107 are connected to the inverter. FIG. 2 depicts additional details of an exemplary multi-port meter. The multi-port meter 212 is connected to grid 200, an inverter 202, and a load 203. The inverter 202 is connected to a DER device 201. The grid 200 is connected to the multi-port meter 212 by a grid port 204, and the inverter 202 is connected to the multi-port meter 212 by an auxiliary port 205. The auxiliary port 205 and the grid port 204 are connected to an auxiliary switch 208 and a grid switch 207 respectively. The multi-port meter 212 is configured to control the state of the grid switch 207 and the state of the auxiliary switch 208. The multi-port meter 212 is also configured to measure phase, amplitude, and/or frequency of the grid 200 and the inverter 202. Metrology components 209 measure the phase, amplitude, and/or frequency of the grid 200 and the inverter output. A processing unit 211 receives metrology information measured by the metrology components 209. The processing unit processes the metrology information of the grid to provide consumption data and other information. The processing unit may also detect a change in a state of the grid. The change in the state of the grid could be a voltage outside of a predetermined threshold, including an outage.

The processing unit may also use the metrology data of the inverter to provide generation data or other information. The processing unit may also compare the inverter output phase, amplitude, and frequency to the phase, amplitude, and frequency of the grid prior to connecting the inverter to the grid. The metrology data may also include a waveform stream, or portions of a waveform. The multi-port meter's processing unit 211 is used to control the multi-port meter's grid and auxiliary switches 208, 207.

Further, the multi-port meter may include memory within the processing unit or separate from the processing unit. The memory may include stored instructions that are executed by the processing unit to perform the functions described herein. The instructions may be provided at manufacture or installation or may be provided over a communication network after the multi-port meter is installed. The inverter may also include a processing unit and memory (not shown) for storing instructions that are executed by the processing unit to perform functions described herein.

Some examples of the multi-port meter include a communications module 210 that enables the meter to communicate on a network with other meters or devices, including a head-end system. The communications module may also allow the meter to communicate with the invertor either using the same network or a separate network. The inverter may also include a communications module (not shown) for communicating with the meter or with other devices.

In some examples of the multi-port meter's communications module, the communication module may be configured for wireless, wired, or power line communication. Wireless communication technologies may include but are not limited to WiFi, radio frequency (RF), ultrahigh frequency including Bluetooth, cellular, satellite, ZigBee, WiMax, and/or other wireless communication technologies. Wired communication may include Ethernet, or other wired communication technologies. Power line communication may include technologies following the P2030.5 standard or other alternative standards for power line communications. The communications module may also use one or more of the following communication protocols: Modbus, CIP, EtherCAT, DNP, IEEE 2030.5, or other communication protocols. Other protocols and derivatives of the previously mentioned communication protocols may also be used.

Additionally, communications between the meter and the inverter may use a variety of techniques including the inverter polling the meter for information, the meter broadcasting information to the inverter, or the inverter streaming information to the meter, or any combination thereof. The information or data communicated to and by the multi-port meter may include amplitude, phase, frequency of the grid or inverter, a waveform stream of the grid or inverter output, or a part of a waveform of the grid or inverter output. Additionally, the multi-port meter may send data on a periodic basis to a remote device, user, inverter, or other device.

Other implementations of the multi-port meter may include additional ports beyond those shown in FIG. 2. If the additional port is associated with a second DER device and/or inverter, the meter may also include an additional auxiliary switch connected to the additional port.

Although FIG. 2 illustrates a single load 203 connected to the meter, other configurations may connect multiple loads to the meter. In one example, multiple premises loads may be connected to the load port of the meter. Each of the premises loads may be connected to its own meter.

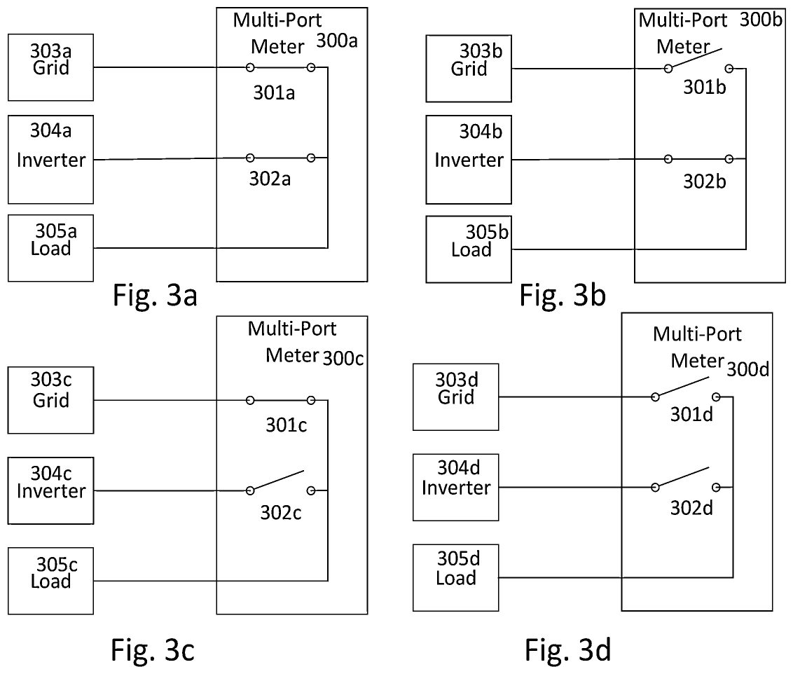

FIGS. 3a-3d depict different states of the grid switch and the auxiliary switch in the multi-port meter. There are four different states of the switches that correspond to open/closed states of the grid switch 301a-d and the auxiliary switch 302a-d. FIG. 3a depicts the multi-port meter 300a in a state that supports grid-tied mode, also referred to as grid-following mode. In this state, the grid switch 301a and the auxiliary switch 302a are both in a closed state. When the multi-port meter is in this state, the inverter and the grid may output power to a load 305a. The output provided by the inverter may track the grid. This means that the inverter may adjust the output the inverter provides to track the frequency, phase, and amplitude of the grid voltage within an allowable tolerance to allow for safe cogeneration of power. The allowable tolerance, i.e. allowable difference in frequency, phase, and amplitude of power between the outputs of the inverter and the power grid, may vary based on jurisdiction, regulatory authority, or other type of requirement. In FIG. 3a, the inverter 304a with a distributed energy resource and the grid 303a are cogenerating power to load 305a.

FIG. 3b depicts the multi-port meter 300b in a state that supports islanding mode, also referred to as grid-forming mode. In this state, the grid switch 301b is in an open state and the auxiliary switch 302b is in a closed state. The inverter 304b may output power to the load 305b. Because the grid switch 301b is open, the grid is unable to provide power to the load 305b and the invertor does not provide power to the grid. The inverter may provide an isochronous output to the load, meaning that the output provided by the inverter does not necessarily track the grid. The output provided by the inverter is not required to synchronize to the phase, frequency, and amplitude of the grid when the inverter is outputting isochronously. The inverter may generate and control the frequency of its output. For example, the frequency may be 60 Hz or 50 Hz depending on the implementation. While in islanding mode, the meter may also send commands to the inverter to change its parameters to specific values for a variety of reasons, including reducing the voltage output to improve efficiency.

FIG. 3c depicts the multi-port meter 300c in a state that is also referred to as a first transitional state. In this state, grid switch 301c is in a closed state, and auxiliary switch 302c is in an open state. The grid 303c may be supplying power to the load 305c. The inverter 304c is disconnected and does not provide power to the load or the grid. This transitional state occurs in some examples when the system transitions between the islanding and grid-tied modes.

FIG. 3d depicts the multi-port meter 300d in a state that is also referred to as a second transitional state. In this state, the auxiliary switch 302d, and the grid switch 301d are both open. When the grid switch 301d and the auxiliary 302d are open, the load 305d is not receiving power from the grid 303d or from the output of the inverter 304d. This state occurs in some examples when the system transitions between the islanding and grid-tied modes.

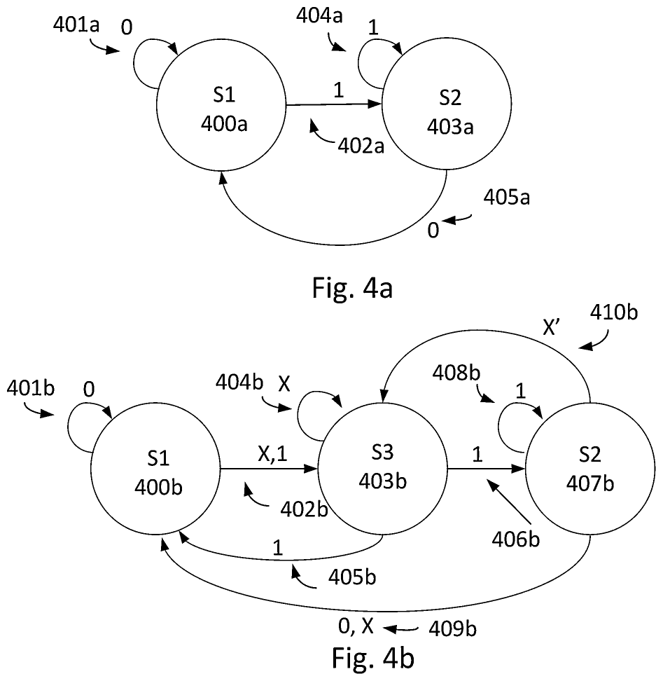

FIGS. 4a and 4b depict different states of the multi-port meter S1 400a, S2 403a, and S3 403b and the transitions between the multi-port meter states. In some examples of the invention, the multi-port meter operates in two states, as shown in FIG. 4a, while in other examples the meter uses one or more transitional states, as shown in FIG. 4b. These states include the states discussed in FIGS. 3a-3d.

The ones and zeros of FIG. 4a represent a factor considered in making the determination to transition between states. In one example, the meter monitors the state of the grid and uses the state of the grid as the factor. When the meter detects an outage on the grid, the meter transitions from grid-tied mode to islanding mode. When the meter detects the restoration of power on the grid, the meter transitions from islanding mode to grid-tied mode. State S1 supports islanding mode and corresponds to a state where the grid switch is open and the auxiliary switch is closed, as shown in FIG. 3b. State S2 supports grid-tied mode and corresponds to a state where the grid switch and the auxiliary switch are closed, as shown in FIG. 3a.

In one example of FIG. 4a, the factor is zero when the grid is in an outage condition and the factor is one when the grid is operational. Beginning with S1, so long as there is an outage on the grid the meter remains 401a in state S1. When the multi-port meter senses the restoration of power on the grid, the multi-port meter transitions 402a from S1 400a to S2 403a. While in S2, so long as the grid is operational, the meter remains 404a in S2. When the meter detects an outage, the multi-port meter transitions 405a from S2 to S1. The transitions illustrated in FIG. 4a may result in there being no power blink or momentary outage at the premises load when the system transitions between the islanding and grid-tied modes.

In some examples, the determination to transition between states of the multi-port meter may be made by devices other than the multi-port meter. The inverter, utility head-end system, or other device may monitor the grid and send a command to the meter to initiate a transition between states of the multi-port meter.

FIG. 4b depicts the same first and second states, S1, S2 as shown in FIG. 4a and adds a third state S3 403b. The third state S3 is a transitional state and corresponds to FIG. 3c, FIG. 3d, or a combination of FIG. 3c and FIG. 3d. FIG. 4b also adds a second factor, X, which corresponds to a command received from a remote device, such as a head-end system. The command may cause the meter to transition between states regardless of the state of the grid.

While in state S1 400b, if the meter receives a command to transition from islanding mode to grid-tied mode, the meter transitions 402b from S1 to S3 and then transitions 406b from S3 to S2. While in state S3, the auxiliary switch may be opened, as shown in FIG. 3d. In some implementations, while the meter is in state S3, the meter transitions from the state where both the grid switch and the auxiliary switch are open, as shown in FIG. 3d, to a state where the grid switch is closed and the auxiliary switch is open, as shown in FIG. 3c. Since state S3 is a transitional state, the meter may proceed relatively quickly to state S2. The transition from S1 to S3 or from S3 to S2 may also require that the meter detect that there is power on the grid for safety reasons.

While in state S2, if the meter receives a command to transition from grid-tied mode to islanding mode, then the meter transitions 409b from S2 to S1. The transition may occur regardless of the state of the grid. For example, the meter may be instructed to operate in islanding mode due to reasons other than a power outage. Other commands received by the meter may include commands to transition 410b the grid switch and the auxiliary switch to states shown in FIG. 3c or 3d or to remain 404b in the transitional state S3.

In the absence of receiving a command, the meter may transition between states S1 and S2 in a manner similar to that described above in connection with FIG. 4a, with the addition of traversing transitional state S3 between S1 and S2. Including one or more transitional states between S1 and S2 may result in a power blink at the premises, which may be minimized by controlling the timing of the switch transitions.

Instead of the meter making the determination to transition between the states shown in FIGS. 4a and 4b, in some implementations, the inverter makes the determination. The inverter may monitor the grid to detect a change in the state of the grid or it may detect a disconnection from the grid when making the determination. The inverter communicates with the meter so the meter may control the grid and auxiliary switches based on the determination made by the inverter.

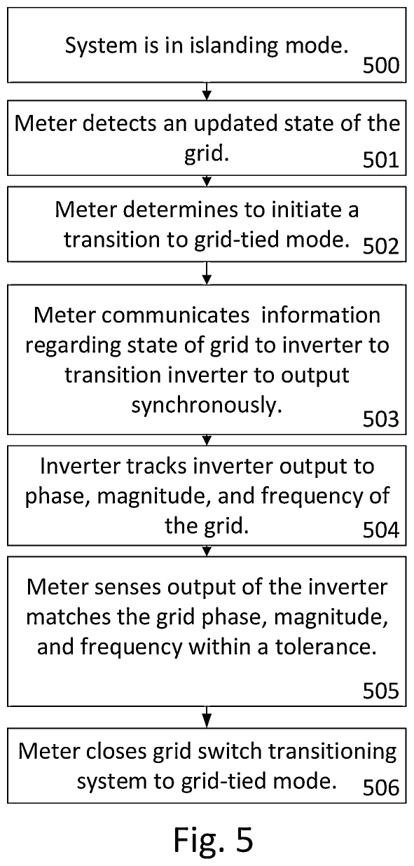

FIG. 5 depicts how the system transitions from islanding mode to grid-tied mode in an example of the system where the meter makes the determination to transition between modes and communicates information to the inverter. The system, starts in islanding mode 500. In islanding mode, the meter is configured as shown in FIG. 3b and the inventor is generating an isochronous output. The meter then detects a change in the state of the grid 501. A change in the state of the grid may be a restoration of power. For example, a restoration of power following a loss of power, where the meter initiated the transition to islanding mode based on the detection of the loss of power on the grid. When the meter detects a change in the state of the grid, the meter may make a determination to leave islanding mode and to initiate the transition to grid-tied mode 502.

The meter communicates with the inverter to inform it of the transition and to provide information regarding phase, amplitude, and frequency of the grid 503. In response, the inverter transitions its output from isochronous to synchronous. The inverter uses the grid information to adjust the inverter's output to match the grid within a tolerance 504. The multi-port meter may provide the inverter with the actual grid voltage and frequency values or may provide the difference between the grid voltage and frequency and the inverter voltage and frequency. The multi-port meter may provide an indication of the relative phase between the grid and the inverter, as well. When the meter senses that the output of the inverter matches the grid within a tolerance 505, the meter closes the grid switch to transition the system from islanding mode to grid-tied mode. The tolerance may be based on a regulatory requirement or a user requirement. In grid-tied mode the meter is configured as shown in FIG. 3a and the inverter is generating a synchronous output. Other examples of this invention may have fewer or more steps in transitioning from islanding to grid-tied mode.

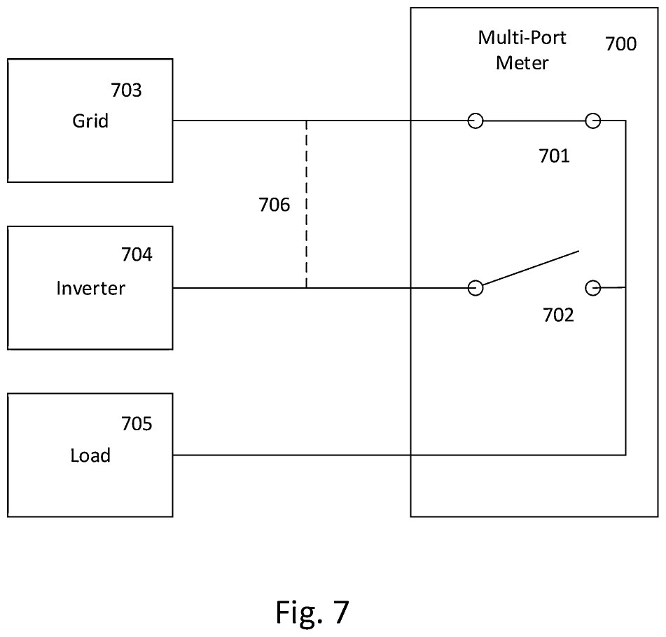

In some alternative examples, the inverter senses the grid voltage, phase and frequency instead of the meter communicating this information to the inverter as in 503. FIG. 7 provides additional details describing how the invertor may monitor the grid. This example has the benefit of not needing communication between the inverter and the multi-port meter in order for the inverter to begin synchronizing the inverter output with the grid.

Other alternatives to the meter sending information about the grid to the inverter include having the meter store the grid information and the inverter request the stored information or having the meter periodically send the grid information to the inverter.

Instead of the meter communicating the transition to the inverter, in some implementations, the meter sends a command to the inverter to restart or opens the auxiliary switch to signal the inverter to transition to a synchronous output. For this type of implementation, the inverter is configured to restart when it senses that the auxiliary switch is open and to provide a synchronous output upon start up.

The multi-port meter may also wait a specified delay time after sensing that the inverter output matches the grid 505 and before connecting the inverter to the grid 506. The delay time ensures that an inverter's output is synchronized with the grid for a set period of time prior to reconnecting with the grid. The duration of the delay time may be configured within the meter. In some instances the duration may be based on a local regulatory requirement or a user requirement. When the inverter has demonstrated that the inverter output is tracking the grid within an allowable tolerance for the set period of time, the multi-port meter may connect the inverter to the grid, typically by closing the grid switch.

Alternatives to the meter determining to initiate the transition to grid-tied mode include having a head-end system or other remote device, a user, or the inverter making the determination. If a head-end system makes the determination, then the head-end system may send a command to the meter or inverter to initiate the transition to grid-tied mode. The command may indicate that the transition is to begin upon receipt of the command or at a future time specified in the command. A user may be able to use a portal or a local user interface to request a transition to grid-tied mode. In some implementations, the user's request may be sent to a head-end system and then the head-end system may instruct the meter. In other implementations, the user's request may be provided directly to the meter. The meter may be configurable to accept or reject a user-initiated command or to verify that the command is authorized. If the meter is configured to verify a user-initiated command and the user requests a transition to grid-tied mode, then the meter verifies the command prior to initiating a transition to grid-tied mode.

An example that includes additional steps to those illustrated in FIG. 5 uses one or more transitional states of the grid switch and the auxiliary switch shown in FIGS. 3c and 3d. The multi-port meter may also decide in 506 to open the multi-port meter's auxiliary switch prior to or near-simultaneous with closing the meter's grid switch so that there is a point where both the grid switch and the auxiliary switch are open. The meter first closes the grid switch and then after the grid switch is closed, the meter closes the auxiliary switch to enter grid-tied mode.

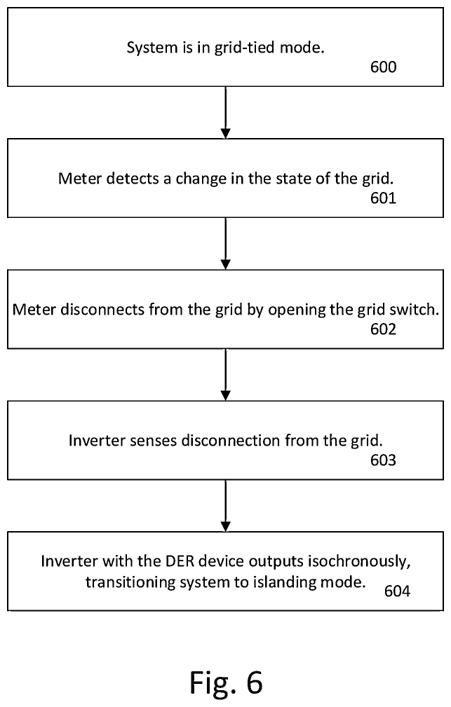

FIG. 6 depicts an example of how the system transitions from grid-tied mode to islanding mode. The system begins in grid-tied mode, with the auxiliary switch and grid switch closed, as shown in FIG. 3a. The meter detects a change in the state of the grid 601. For example, the meter may detect an outage on the grid or a deterioration in the power provided by the grid. The meter initiates a transition from grid-tied mode to islanding mode. The meter disconnects from the grid by opening the grid switch 602. When the meter disconnects from the grid by opening the grid switch, the multi-port meter transitions from the state supporting grid-tied mode FIG. 3a, to the state supporting islanding mode FIG. 3b.

The inverter then senses disconnection from the grid 603. The inverter then outputs power from the DER device isochronously, transitioning the system to islanding mode 604.

Other examples may include the multi-port meter communicating to the inverter a change in the state of the grid instead of or in addition to the inverter sensing the disconnection 603.

In other examples of 603, the multi-port meter may instead of or in addition to 603, communicate the change in the state of the grid to the inverter. The multi-port meter may control the inverter, issuing commands to the inverter to generate an isochronous output.

The multi-port meter may also decide in 602 to transition the multi-port meter using the transitional states of FIG. 3c or FIG. 3d. In some examples, the transitional states occur as the system transitions between the state supporting grid-tied mode and the state supporting islanding mode. For example, the meter may transition from the state shown in FIG. 3a, which supports grid-tied mode to the state shown in FIG. 3d, where both the grid switch and the auxiliary switch are open, to the state shown in FIG. 3b, which supports islanding mode. The transition between the state supporting grid-tied mode and the state supporting islanding mode may be near-instantaneous, with the multi-port meter being in a transitional state for a brief period of time. Other examples include the multi-port meter making a determination or receiving a command to maintain a transitional state for a longer period of time.

Alternatives to the meter determining to initiate the transition to islanding mode include having a head-end system or other remote device, a user, or the inverter making the determination. If a head-end system makes the determination, then the head-end system may send a command to the meter or inverter to initiate the transition to islanding mode, similar to that described above in connection with FIG. 6.

FIG. 7 depicts an alternative example where the inverter monitors the state of the grid. Between the inverter and the grid is an optional connection 706. This connection may be a physical connection, such as a wire or a connection through the meter socket, or a wireless connection through a sensor or other device. In this example, the inverter may sense the state of the grid through the connection to the grid. When the inverter senses a change in the state of the grid, the inverter may communicate the change with the multi-port meter, and/or send a command to the multi-port meter to transition to islanding mode or to transition to grid-tied mode.

Other examples do not require a separate connection 706 for the inverter to sense a change in the state of the grid. The inverter may be configured to sense a change in impedance at the auxiliary port of the multi-port meter to detect a change in the state of the grid. The inverter may communicate a command to the multi-port meter to transition the multi-port meter between states. The inverter may adjust the inverter' s output with the transition of the multi-port meter between states to transition the system between modes.

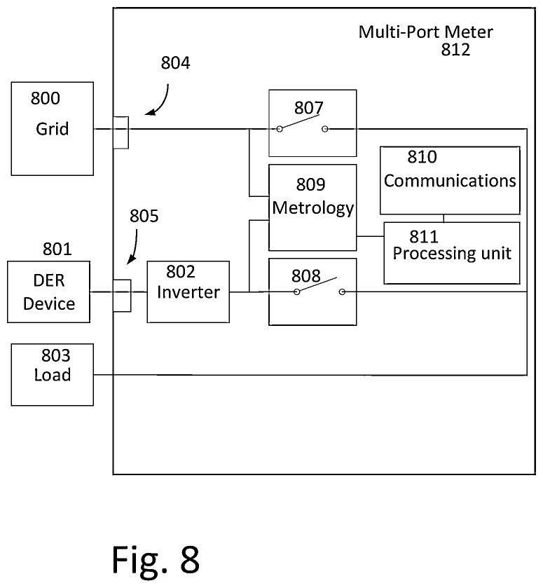

An alternative multi-port meter configuration integrates the inverter into the meter. FIG. 8 illustrates an exemplary multi-port meter 812 with an integrated inverter 802. The multi-port meter 812 is connected to grid 800, a DER device 801, and a load 803. The grid 800 is connected to the multi-port meter 812 by a grid port 804, and the DER device 801 is connected to the inverter 802 by auxiliary port 805. The grid port 804 is connected to a grid switch 807 and the inverter 802 is connected to the auxiliary switch 808. The multi-port meter is configured to control the state of the grid switch and the state of the auxiliary switch. The multi-port meter 812 is also configured to measure phase, amplitude, and/or frequency of the grid 800 and the inverter output. Metrology components 809 measure the phase, amplitude, and/or frequency of the grid and the inverter output. A processing unit 811 receives metrology information measured by the metrology components 809. The processing unit processes the metrology information of the grid to provide consumption data and other information. The processing unit may also detect a change in a state of the grid. The change in the state of the grid could be a voltage outside of a predetermined threshold, including an outage. The multi-port meter 812 and the inverter 802 may also include processing units and communications modules, as described above in connection with FIG. 2, as well as perform the operations described herein.

Previous solutions for controlling DER devices include the use of expensive automatic transfer switches (ATS). An ATS requires additional installation into the micro-grid. Additionally, some ATS systems do not allow for generation of power while the electric power grid is inoperative, or during maintenance times. Although the present solution can be implemented without the need for an ATS, it may also be implemented in an existing system that includes an ATS without having to remove the ATS, saving on installation costs.

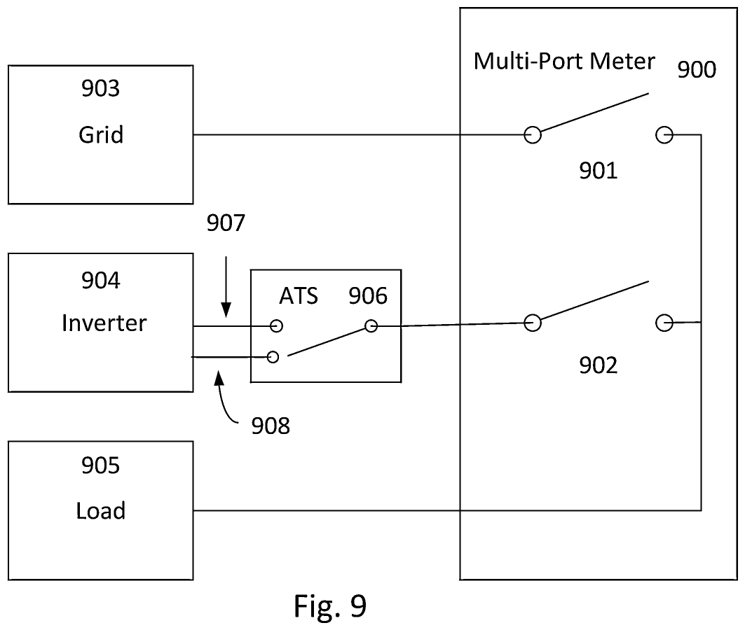

FIG. 9 depicts a multi-port meter 900 with grid switch 901 and auxiliary switch 802. The multi-port meter is connected to a grid 903 and an ATS 906, with the ATS being connected to an inverter 904. The multi-port meter is also connected to a load 905. The inverter includes two outputs. One output corresponds to a synchronous output 907 and the other output corresponds to an isochronous output 908. Both of the inverter outputs are connected to the ATS. The multi-port meter may be configured to communicate with the ATS to control the connection of one of the inverter outputs to the auxiliary port of the meter based on whether the system is in islanding mode or grid-tied mode.

In this example, inverter output 907 is connected to an AC Grid connection of the ATS. When the grid switch 901 is closed, the inverter 904 is connected to the ATS by output 907, and the inverter is configured to output synchronously with the grid. When the grid switch 901 is open, the inverter output 908 is connected to a protected load connection of the ATS, and the inverter output 908 is provided to the load.

The multi-port meter may communicate with the ATS to coordinate the timing of opening and closing switches of the multi-port meter and with the timing of the ATS switching between the 907 and 908 connections. Other examples may include connecting a sensor to the grid from either the inverter or the ATS to enable ATS switching or synchronization of the inverter output with the phase, frequency, and/or amplitude of the grid.

While the present subject matter has been described in detail with respect to specific aspects thereof, it will be appreciated that those skilled, upon attaining an understand of the foregoing, may readily produce alternations to, variations of, and equivalents to such aspects. Accordingly , it should be understood that the present disclosure has been presented for purposes of example rather than limitation and does not preclude inclusion of such modifications, variations, and/or additions to the present subject matter as would be readily apparent to one of ordinary skill in the art.

What is claimed is:

1. A system for controlling islanding, comprising:
a multi-port meter comprising:
a grid port configured for connecting the meter to an electric power grid;
an auxiliary port configured for connecting the meter to an external inverter;
a load port configured for connecting the meter to a premises load;
a grid switch connected to the grid port and configured for connecting the grid port to the load port and an auxiliary switch;
the auxiliary switch connected to the auxiliary port and configured for connecting the auxiliary port to the grid switch and the load port; and
a processing unit configured for processing power grid data measured by the meter and controlling states of the grid switch and the auxiliary switch; and
the inverter, wherein the inverter is connected to a distributed energy resource device and is configurable for operating in an islanding mode, wherein an inverter output transitions from a synchronous output to an isochronous output when the grid switch transitions from a closed state to an open state, wherein the synchronous output tracks voltage, frequency, and phase of the electric power grid and the isochronous output uses an inverter-generated voltage, frequency, and phase.

2. The system of claim 1, wherein the processing unit is configured to control the grid switch to the open state when the power grid data measured by the meter indicates a power outage.

3. The system of claim 2, wherein the meter further includes a communication module for communicating with a remote system and the processing unit is configured to control the grid switch to the open state in response to the communication module receiving a command from the remote system to open the grid switch.

4. The system of claim 1, wherein the meter further includes a communication module for communicating with the inverter and the communication module sends a message to the inverter to transition from generating the synchronous output to generating the isochronous output when the processing unit controls the grid switch to transition from the closed state to the open state.

5. The system of claim 1, wherein the inverter monitors the electric power grid, and the inverter output transitions from the synchronous output to the isochronous output when the inverter detects a power outage.

6. The system of claim 1, wherein the inverter monitors an impedance of the auxiliary port and the inverter output transitions from the synchronous output to the isochronous output when the inverter detects an impedance outside a predetermined threshold that corresponds to an open state of the grid switch.

7. The system of claim 2, wherein the processing unit is configured to detect an end of the power outage, determine when the inverter is providing the synchronous output, and control the grid switch to transition from the open state to the closed state.

8. The system of claim 1, wherein the inverter has multiple outputs, the multiple outputs of the inverter are connected to an automatic transfer switch system, and the automatic transfer switch system is connected to the auxiliary port.

9. A method for reconnecting an inverter to an electric power grid comprising:
controlling, by a multi-port meter, a grid switch and an auxiliary switch of the multi-port meter to operate in an islanding mode where the inverter provides power to a load connected to the meter and the multi-port meter is disconnected from the electric power grid;
while operating in the islanding mode, determining by the multi-port meter to transition to grid-tied mode;
detecting, by the multi-port meter, a phase, an amplitude, and a frequency of the electric power grid;
communicating from the multi-port meter to the inverter a command to transition to the grid-tied mode from the islanding mode;
monitoring, by the multi-port meter, a phase, an amplitude, and a frequency of the inverter output;
confirming, by the multi-port meter, that the phase, the amplitude, and the frequency of the inverter output are within a predetermined tolerance of the phase, the amplitude, and the frequency of the electric power grid; and
controlling, by the multi-port meter, the grid switch and the auxiliary switch to reconnect the inverter to the electric power grid and operating in grid-tied mode.

10. The method of claim 9, wherein controlling, by the multi-port meter, the grid switch and the auxiliary switch to reconnect the inverter to the power grid, comprises:
opening the auxiliary switch while the grid switch remains open;
closing the grid switch; and
closing the auxiliary switch after closing the grid switch.

11. The method of claim 9, wherein determining by the multi-port meter to transition to grid-tied mode, comprises receiving, by the multi-port meter, a command from a remote system to transition to grid-tied mode or detecting, by the multi-port meter a restoration of power on the electric power grid.

12. The method of claim 9, wherein controlling, by the multi-port meter, a grid switch and an auxiliary switch of a multi-port meter so that the inverter provides power to a load connected to the meter and the multi-port meter is disconnected from the electric power grid, comprises maintaining the grid switch in an open state and maintaining the auxiliary switch in a closed state.

13. The method of claim 9, further comprising:
sending, from the multi-port meter to the inverter, information regarding the phase, amplitude, and frequency of the electric power grid prior to confirming that the phase, the amplitude, and the frequency of the inverter output are within a predetermined tolerance of the phase, the amplitude, and the frequency of the electric power grid.

14. The method of claim 9, wherein communicating from the multi-port meter to the inverter a command to transition to the grid-tied mode from the islanding mode includes a command to restart the inverter.

15. The method of claim 9, wherein the multi-port meter sends information regarding the phase, amplitude, and frequency of the electric power grid to the inverter periodically.

16. The method of claim 9, further comprising:
while operating in the grid-tied mode, controlling, by the multi-port meter, the grid switch and the auxiliary switch of the multi-port meter so that the inverter provides at least a portion of power consumed by the load connected to the meter and the multi-port meter is connected to the electric power grid;
while operating in the grid-tied mode, initiating by the multi-port meter a transition to the islanding mode;
communicating from the multi-port meter to the inverter a command to transition to the islanding mode from the grid-tied mode; and
controlling, by the multi-port meter, the grid switch and the auxiliary switch to disconnect the inverter from the electric power grid.

17. A method for disconnecting an inverter from an electric power grid and entering islanding mode comprising:
operating the inverter and a multi-port meter in grid-tied mode, wherein while operating in the grid-tied mode, the inverter provides a synchronous output and the multi-port meter controls a grid switch and an auxiliary switch to connect the synchronous output of the inverter and an electric power grid to a premises load;
while operating in the grid-tied mode, determining by the inverter to transition to an islanding mode;
communicating, from the inverter to the multi-port meter, a command to transition to the islanding mode;
transitioning the synchronous output to an isochronous output; and
operating the inverter and the multi-port meter in the islanding mode, wherein while operating in the islanding mode, the multi-port meter controls the grid switch and the auxiliary switch to connect the isochronous output of the inverter to the premises load and to disconnect the multi-port meter from the electric power grid.

18. The method of claim 17, wherein determining by the inverter to transition to an islanding mode, comprises receiving, by the inverter a command from a remote system to transition to the islanding mode, detecting, by the inverter a loss of power on the electric power grid, or detecting, by the inverter an impedance outside a predetermined threshold that corresponds to an open state of the grid switch.

19. The method of claim 17, wherein the inverter provides a synchronous output by tracking a voltage, a frequency, and a phase of the electric power grid.

20. The method of claim 17, wherein in response to receiving the command to transition to the islanding mode from the inverter, the multi-port meter controls the grid switch to an open state.
